(19) United States
(12) Patent Application Publication
(10) Pub. No.: US 2011/0264438 A1
(43) Pub. Date: Oct. 27, 2011

(54) Search and display system that provides example sentences compliant with geographical information and the method of the same

(75) Inventors: Chaucer Chiu, Taipei (TW); Huchen Xu, Shanghai (CN)

(73) Assignee: INVENTEC CORPORATION, Taipei (TW)

(21) Appl. No.: 12/805,977

(22) Filed: Aug. 27, 2010

(30) Foreign Application Priority Data
Apr. 27, 2010 (TW) 099113281

(51) Int. Cl. G06F 17/28

(52) U.S. Cl. 704/3

(57) ABSTRACT

A search and display system that provides example sentences compliant with geographical information receives search information from an input area, a display area, or an electronic map. The system finds type information corresponding to the search information. At least one example category corresponding to the type information is searched in an example sentence database. At least one substitute example sentence corresponding to the selected example sentence category is searched in the example sentence database. This achieves the goal of providing example sentences compliant with the geographical information. The method of the same is also provided.

### BACKGROUND OF THE INVENTION

1. Field of Invention

The invention relates to an example sentence search and display system and the method of the same. In particular, the invention relates to a search and display system that receives search information in an input area, a display area, or an electronic map, displays the corresponding substitute example sentence compliant with the geographical information. The invention also relates to the method of the same.

2. Related Art

Most people resort to travel agencies to plan foreign trips and then select one from the suggestions. This method is not only convenient and can avoid some complicated paper works and language problems. However, the planned trips may not be suitable for everybody. Therefore, more and more people start to plan their own trips.

For such travelers, the primary difficulty is in language and communications. To solve these problems, a traveler's conversation system has been developed. Such a system can provide a traveler with conversations in different languages, greatly easing the communications for the traveler.

Current traveler's conversation systems provide fixed conversation example sentences. They also provide the traveler with a search interface to search for appropriate conversations. They usually categorize the conversations to facilitate the search.

However, the current traveler's conversation systems merely provide fixed conversation example sentences. That is, the provided example sentences may not match the geographical information of the traveler. The conversation example sentences provided by such fixed traveler's conversation systems are very boring. It is highly desirable if the contents of conversation example sentences can match with the geographical information of the traveler. Such sentences will be more useful.

In summary, the prior art always has the problem of only providing fixed conversation example sentences. They generally do not match the geographical information of the traveler to provide useful help. It is imperative to provide a solution.

### SUMMARY OF THE INVENTION

In view of the foregoing, the invention discloses a search and display system that provides example sentences compliant with current geographical information of the traveler. The invention also discloses the method of the same.

The search and display system that provides example sentences compliant with current geographical information according to the invention includes: a geographical information database, an example sentence database, and interface display module, a receiving module, a category selection module, a search module, and a display module.

The geographical information database stores name information, type information, coordinate information, and display information. The name information, the type information, the coordinate information, and the display information are all stored in a first language explanation and a second language translated explanation. The example sentence database stores type information, at least one example sentence category, and at least one substitute example sentence. The type information, the at least one example sentence category, and the at least one substitute example sentence are all stored in a first language explanation and a second language translated explanation. The interface display module displays a user interface that includes an electronic map, an input area, and a display area. The receiving module receives search information in the input area, the display area, and the electronic map. The search information can be one of the name information, the type information, and the coordinate information. The category selection module selects at least one example sentence category. The search module finds the corresponding type information and display information from the geographical information database according to the search information. At least one example sentence category is correspondingly found in the example sentence database according to the type information. Alternatively, at least one substitute example sentence is correspondingly found in the example sentence database according to the selected example sentence category. The display module shows in the display area the name information, the display information, the at least one example sentence category, or the at least one substitute example sentence, or shows in the electronic map the name information or display information.

The above-mentioned search and display system that provides example sentences compliant with current geographical information further includes a scale adjusting module for adjusting the size of the electronic map according to a scale factor. When the scale factor reaches its default value, the display information is shown in the electronic map via the display module.

In the above-mentioned search and display system that provides example sentences compliant with current geographical information, the receiving module further receives example sentence information in the input area. The search module compares the example sentence information with at least one substitute example sentence in order to find the corresponding type information in the example sentence database. The type information is used to find the name information, the coordinate information, and the display information in the geographical information database. The name information or the display information is shown in the display area via the display module. When the selecting module selects the name information or the display information, the display module shows the name information or the display information at a place in the electronic map that corresponds to the coordinate information, respectively.

In the above-mentioned search and display system that provides example sentences compliant with current geographical information, the electronic map is pre-installed. Alternatively, the electronic map can be imported into the example sentence search and display system. Besides, the electronic map consists of an information layer, a coordinate layer, and a map layer.

The search and display method that provides example sentences compliant with geographical information according to the invention includes the following steps.

First, the method establishes a geographical information database that stores name information, type information, coordinate information, and display information. The name information, the type information, the coordinate information, and the display information are all stored in a first language explanation and a second language translated explanation. Afterwards, the method establishes in advance an example sentence database that stores the type information, at least one example sentence category, and at least one substitute example sentence. The type information, the at least one example sentence category, and the at least one substitute example sentence are all stored in a first language explanation and a second language translated explanation. Afterwards, a user interface containing an electronic map, an input area, and a display area is displayed. Search information is then received from the input area, the display area, or the electronic map. The search information can be one of the name information, the type information, and the coordinate information. Afterwards, the search information is used to find the corresponding type information and the display information from the geographical information database. The display information is then shown in the display area or the electronic map. Afterwards, at least one example sentence category is found from the example sentence database according to the type information. At least one example sentence category is shown in the display area. Afterwards, at least one of the example sentence categories is selected. According to the selected example sentence category, at least one substitute example sentence is found in the example sentence database. Finally, the at least one substitute example sentence is shown in the display area.

The above-mentioned search and display method that provides example sentences compliant with geographical information further includes the step of adjusting the size of the electronic map according to a scale factor. In the step of showing the display information in the display area or the electronic map, the display information is shown in the electronic map when the scale factor reaches a default value.

The above-mentioned search and display method that provides example sentences compliant with geographical information further includes the following steps.

First, example sentence information is received in the input area. The example sentence information is compared with at least one substitute example sentence in order to find corresponding type information from the example sentence database. Afterwards, the name information, the coordinate information, and the display information are found from the geographical information database according to the type information. The name information or the display information is shown in the display area. Afterwards, one of the name information or the display information is selected. Finally, the selected name information or display information is shown at a place in the electronic map with the corresponding coordinate information.

In the above-mentioned search and display method that provides example sentences compliant with geographical information, the electronic map is pre-installed in the user interface or imported into the user interface. Moreover, the electronic map consists of an information layer, a coordinate layer, and a map layer.

As described above, the invention differs from the prior art in that the invention shows the input area, the display area, and the electronic map in the user interface. It then receives the search information from the input area, the display area, and the electronic map. The search information can be one of the name information, the type information, and the coordinate information. The search information is used to find the corresponding type information and display information from the geographical information database. At least one example sentence category is found from the example sentence database according to the type information. After the user selects an example sentence category, at least one substitute example sentence is found from the example sentence database according to the selected example sentence category. At least one substitute example sentence is shown in the display area of the user interface. The name information or the display information can be shown in the electronic map.

Using the disclosed technique, the invention can achieve the goal of providing example sentences compliant with geographical information.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed search and display system that provides example sentences compliant with geographical information;

FIG. 2A is a flowchart of the disclosed search and display method that provides example sentences compliant with geographical information;

FIG. 2B is a flowchart of the additional functions for the disclosed search and display method that provides example sentences compliant with geographical information;

FIG. 3A is a schematic view of the geographical information database according to the invention;

FIG. 3B is a schematic view of the example sentence database according to the invention;

FIG. 4 is a schematic view of the user interface and the search result according to the invention;

FIG. 5A is a schematic view of the user interface and the display result according to the invention;

FIG. 5B is a schematic view of the user interface and the search result according to the invention;

FIG. 6 is a schematic view of the user interface and the search according to the invention; and

FIG. 7 is a schematic view of the user interface and the inverse search result according to the invention.

### DETAILED DESCRIPTION OF THE INVENTION

The present invention will be apparent from the following detailed description, which proceeds with reference to the accompanying drawings, wherein the same references relate to the same elements.

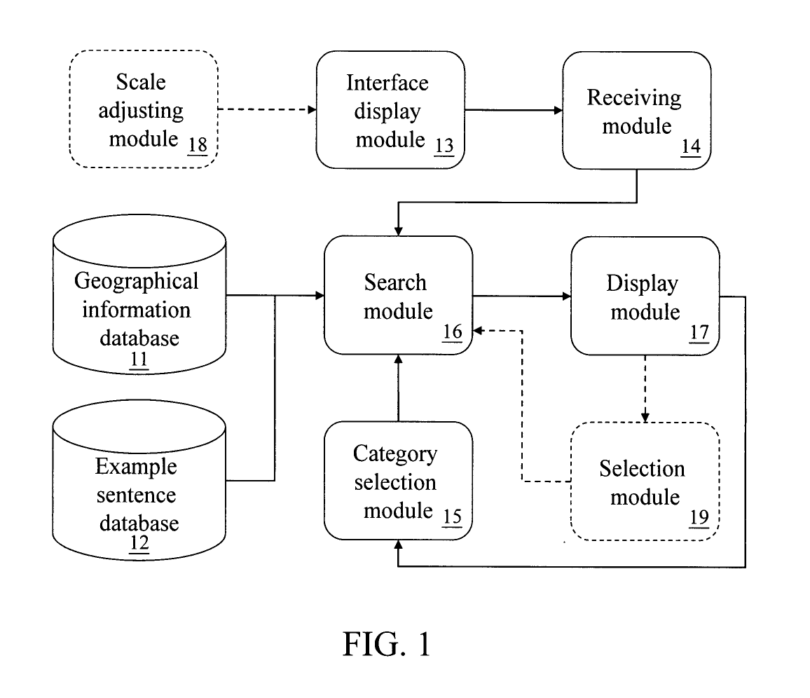

The following paragraphs first explain the search and display system that provides example sentences compliant with geographical information. Please refer to FIG. 1, which is a system block diagram of the disclosed system.

The system includes: a geographical information database 11, an example sentence database 12, an interface display module 13, a receiving module 14, a category selecting module 15, a search module 16, and a display module 17.

The geographical information database 11 stores name information, type information, coordinate information, and display information. The name information can be the name of some building or a particular place, such as a power company, the Central Park, etc. The type information records the type of the building or particular place, such as hospital, marketplace, hotel, etc. The coordinate information contains the longitudinal and latitude coordinates of the building or particular place, such as 121° 48′ 38″ E, 31° 25′ 17″ N, etc. The display information involves a text description and picture of some building or particular place. The name information, the type information, the coordinate information, and the display information are correspondingly stored to establish the geographical information database 11.

It should be noted that the name information, the type information, the coordinate information, and the display information are all stored in a first language explanation and a second language translated explanation in the geographical information database 11. The first language explanation is in the language normally used by the user, explaining the name information, the type information, the coordinate information, and the display information. Suppose the user normally uses ‘Chinese’. Then the name information, the type information, the coordinate information, and the display information can be respectively “Chinese explanation for ‘First Hospital’”, “Chinese explanation for ‘hospital’”, “Chinese explanation for ‘121° 48′ 38″ E and 31° 25′ 17″ N’”, and “Chinese explanation for ‘The First Hospital is the largest hospital . . . ’”. These are only examples used to explain the invention and should not be used to restrict the scope thereof.

Moreover, the name information, the type information, the coordinate information, and the display information all stored in a first language explanation and a second language translated explanation in the geographical information database 11. The second language translated explanation is the translated explanation of the first language explanation in the commonly used language at the user's current location. Suppose the user is located in ‘England’, and the language used in ‘England’ is ‘English’. In this case, the name information, the type information, the coordinate information, and the display information are respectively ‘First Hospital’, ‘hospital’, ‘121° 29′43 E″ and 31° 14′30″ N’, and ‘The First Hospital is the largest hospital . . . ’. These are only examples used to explain the invention and should not be used to restrict the scope thereof.

The example sentence database 12 stores type information, at least one example sentence category, and at least one substitute example sentence. The type information is already described before when introducing the geographical information database 11. It is not repeated here again. At least one example sentence category is used to classify different example sentences according to different type information. For example, suppose the type information is ‘marketplace’. The provided example sentence category can be ‘I want to buy . . . ’, ‘How much is . . . ?’, etc. At least one substitute example sentence provides different substitute example sentences according to different example sentence categories. For example, suppose the example sentence category is ‘I want to buy . . . ’. The provided substitute example sentences can be ‘I want to buy a fan.’, ‘I want to buy a television’, etc. The example sentence database 12 is established by storing the above-mentioned type information, the at least one example sentence category, and at least one substitute example sentence.

It should be noted that the type information, the at least one example sentence category, and at least one substitute example sentence are all stored in a first language explanation and a second language translated explanation in the example sentence database 12. The first language explanation contains the explanation of the type information, the at least one example sentence category, and at least one substitute example sentence in the language normally used by the user. Suppose the user normally uses ‘Chinese’. The type information, the at least one example sentence category, and at least one substitute example sentence can be respectively “Chinese explanation for ‘marketplace’”, “Chinese explanation for ‘I want to buy . . . ’”, and “Chinese explanation for ‘I want to buy a fan.’”. These are only examples used to explain the invention and should not be used to restrict the scope thereof.

Moreover, the type information, the at least one example sentence category, and at least one substitute example sentence are all stored in a first language explanation and a second language translated explanation in the example sentence database 12. The second language translated explanation is the translated explanation of the first language explanation in the commonly used language at the user's current location. Suppose the user is located in ‘England’, and the language used in ‘England’ is ‘English’. The name information, the type information, the coordinate information, and the display information are respectively ‘marketplace’, ‘I want to buy . . . ’, and ‘I want to buy a fan.’. These are only examples used to explain the invention and should not be used to restrict the scope thereof.

The above-mentioned geographical information database 11 and example sentence database 12 are pre-established. The related descriptions are only examples for the purpose of illustration. They should not be used to restrict the scope of the invention.

When the user starts the disclosed example sentence search and display system, the interface display module 13 first displays a user interface containing an electronic map, an input area, and a display area. The user can perform information input and clicks in the electronic map, the input area, and the display area of the user interface. The results of these operations are also shown in the electronic map or the display area.

The electronic map displayed in the user interface is pre-installed in the disclosed example sentence search and display system. This is a common approach, and is not repeated herein. The electronic map can be established using existing technology or imported from another place. The imported method can be through the Internet. For example, suppose the electronic map is imported into the disclosed example sentence search and display system via the Internet. One first needs to attain agreement from the electronic map developer. Afterwards, the area required to be displayed in the electronic map is set in the user interface. That is, the user can use the application programming interface (API) provided by the electronic map developer to import the electronic map into the area to display in the electronic map of the user interface via the Internet.

After the interface display module 13 displays the user interface, the user can enter the search information in the input area thereof. That is, the user uses the first language to enter the search information. The search information can be the name information, the type information, or their combination. The receiving module 14 receives the search information entered by the user. The following three embodiments show the procedures of searching and displaying using different search information.

In the first embodiment, the receiving module 14 receives the search information, which is the name information, the type information, or their combination. When the search information contains the type information, the search module 16 uses the type information to find the corresponding type information and display information in the geographical information database 11. It further finds at least one example sentence category in the example sentence database 12 according to the type information.

Afterwards, the display module 17 shows in the display area of the user interface at least one example sentence category found by the display module 16. That is, the first language explanation and the second language translated explanation of the at least one example sentence category are simultaneous shown. The user can select at least one example sentence category in the display area of the user interface through the category selection module 15 in order to continue the search.

After selecting an example sentence category from the category selection module 15, the search module 16 finds at least one substitute example sentence from the example sentence database 12 according to the example sentence category selected by the category selection module 15. The display module 17 shows the substitute example sentence found by the search module 16 in the display area of the user interface. The display module 17 simultaneously shows the first language explanation and the second language translated explanation of the substitute example sentence.

According to the second embodiment, the search information received by the receiving module 14 is the name information. The search module 16 uses the search information to find the corresponding type information and the display information from the geographical information database 11. In this case, the display module 17 displays the display information and the name information found by the search module in the display area of the user interface. The display module simultaneously displays the first language explanation and the second language translated explanation of the display information and the name information.

The user can select the display information or name information to search in the display area of the user interface. In this case, the search module 16 finds the corresponding coordinate information from the geographical information database 11 according to the selected display information or name information. At least one example sentence category is found in the example sentence database 12 according to the category information corresponding to the selected display information or name information.

Afterwards, the display module 17 shows in the display area of the user interface at least one example sentence category found by the search module 16. The display module 17 displays the name or display information at the place with the coordinate information in the electronic map. The display module 17 simultaneously shows the first language explanation and the second language translated explanation of the name or display information. The user can then select one of the example sentence categories in the display area of the user information via the category selection module 15 in order to continue the search.

After selecting an example sentence category in the category selection module 15, the search module 16 finds at least one substitute example sentence from the example sentence database 12 according to the example sentence category selected by the category selection module. The display module 17 shows the substitute example sentence found by the search module 16 in the display area of the user interface. The display module 17 simultaneously shows the first language explanation and the second language translated explanation of the substitute example sentence.

According to the third embodiment, the user can also select the search information by clicking in the electronic map of the user interface. In this case, the search information is the coordinate information. The search information entered by the user is then received by the receiving module 14.

After the receiving module 14 receives the search information, the search module 16 finds the corresponding type information in the geographical information database 11. At least one example sentence category is then found from the example sentence database 12 according to the type information.

Afterwards, the display module 17 displays the at least one example sentence category found by the search module 16 in the display area of the user interface. That is, the first language explanation and the second language translated explanation of the at least one example sentence category are simultaneously shown. The user then selects one of the example sentence categories in the display area of the user interface using the category selection module 15 for further searches.

After the category selection module 15 selects the example sentence category, the search module 16 finds at least one substitute example sentence from the example sentence database 12 according to the selected example sentence category. The display module 17 shows the substitute example sentence found by the search module 16 in the display area of the user interface. The display module 17 simultaneously shows the first language explanation and the second language translated explanation of the substitute example sentence.

The disclosed search and display system that provides example sentences compliant with geographical information further includes a scale adjusting module 18. The scale adjusting module 18 adjusts the size of the electronic map according to a scale factor. That is, the display module 17 shows the name or display information at the place with the obtained coordinate information in the electronic map. The scale adjusting module 18 adjusts the size of the electronic map so that the scale factor reaches a predetermined value, and then shows the name or display information at the place with the obtained coordinate information.

According to the disclosed search and display system that provides example sentences compliant with geographical information, in addition to using the search information to find substitute example sentences, the user can enter example sentence information in the input area of the user interface as well. The example sentence information is a sentence entered by the user in the first language. The receiving module 14 receives the example sentence information and performs an inverse search.

After the receiving module 14 receives the example sentence information, it is compared with at least one substitute example sentence stored in the example sentence database 12 by the search module 16. When the example sentence information matches with at least one substitute example sentence in the example sentence database 12, the search module finds the type information of the example sentence information.

The search module 16 finds the name information, the coordinate information, and the display information from the geographical information database 11 according to the obtained type information. The display module 17 then shows the name or display information in the display area of the user interface. The first language explanation and the second language translated explanation of the name or display information are simultaneously displayed.

When the user uses the selection module 19 to select one of the name and display information in the display area of the user interface, the display module 17 shows the selected name or display information at the place with the corresponding coordinate information in the electronic map. When the display module 17 shows the selected name or display information, the scale adjusting module 18 first adjusts the size of the electronic map in the user interface so that the scale factor reaches a predetermined value. Therefore, the selected name or display information is shown in the electronic map of the user interface. The first language explanation and the second language translated explanation of the selected name or display information are simultaneously displayed.

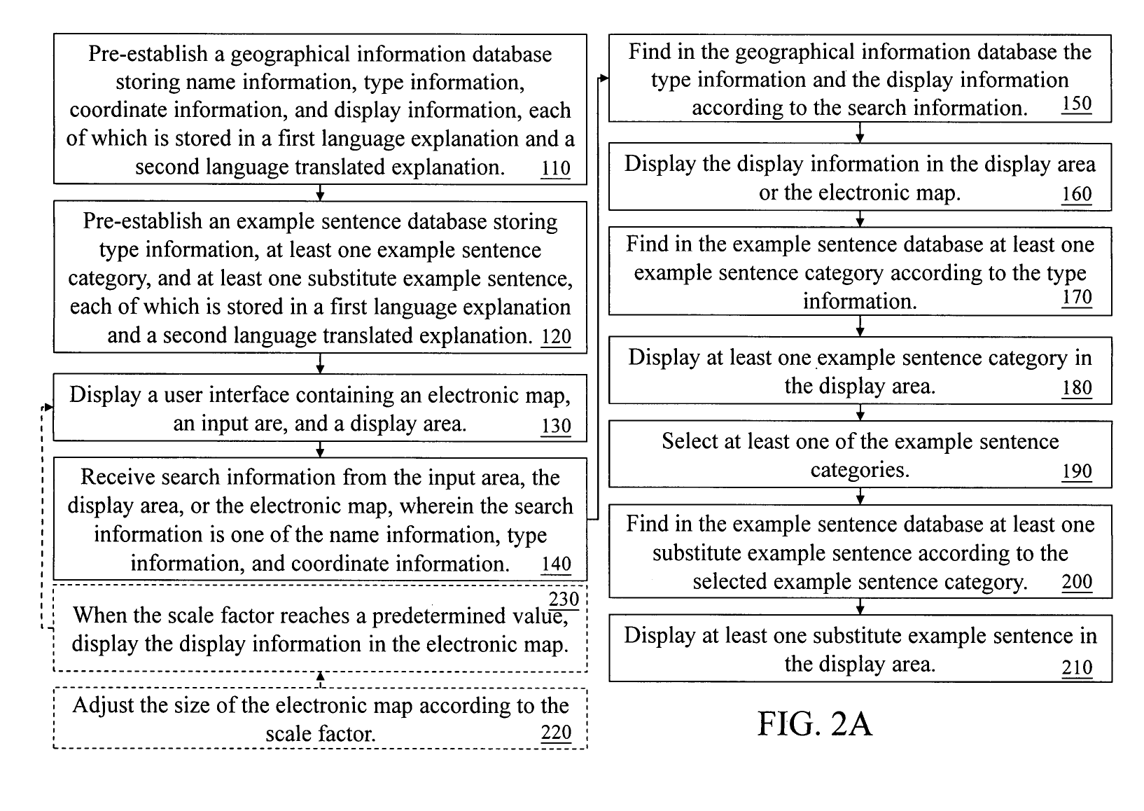

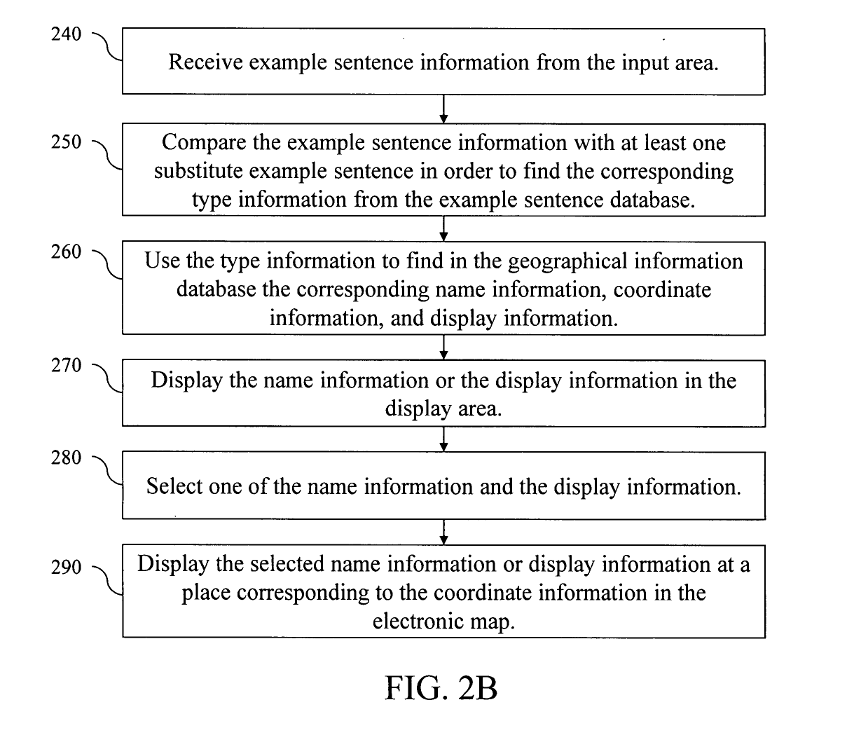

In the following, an embodiment is used to explain the operation and procedure of the invention, with simultaneous reference to FIGS. 1, 2A, and 2B. FIG. 2A is a flowchart of the search and display method that provides example sentences compliant with geographical information. FIG. 2B is a flowchart of the additional functions of the search and display method that provides example sentences compliant with geographical information.

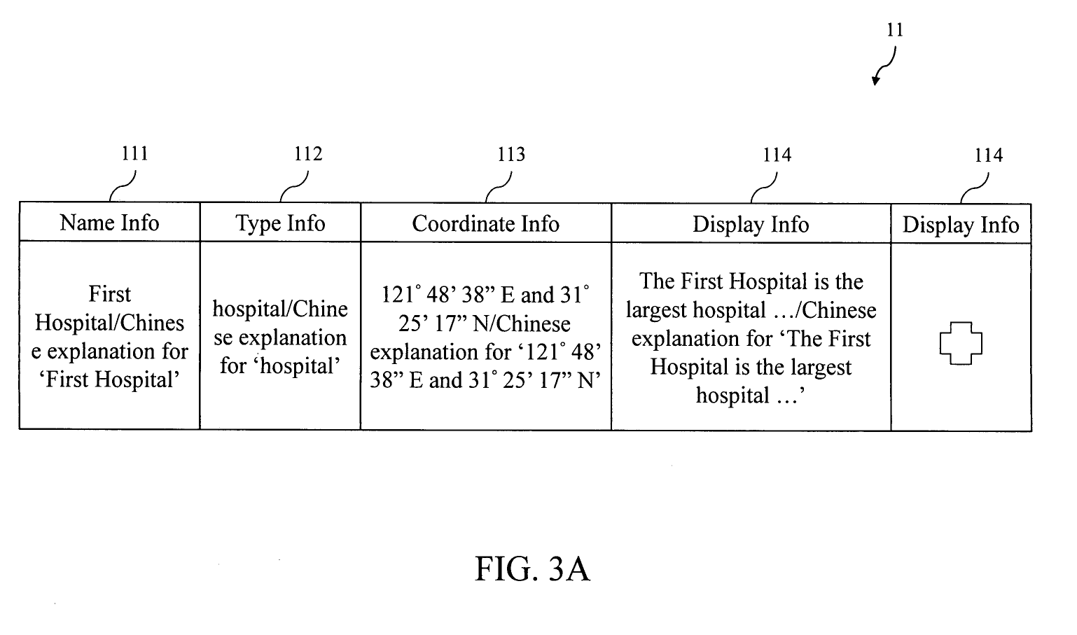

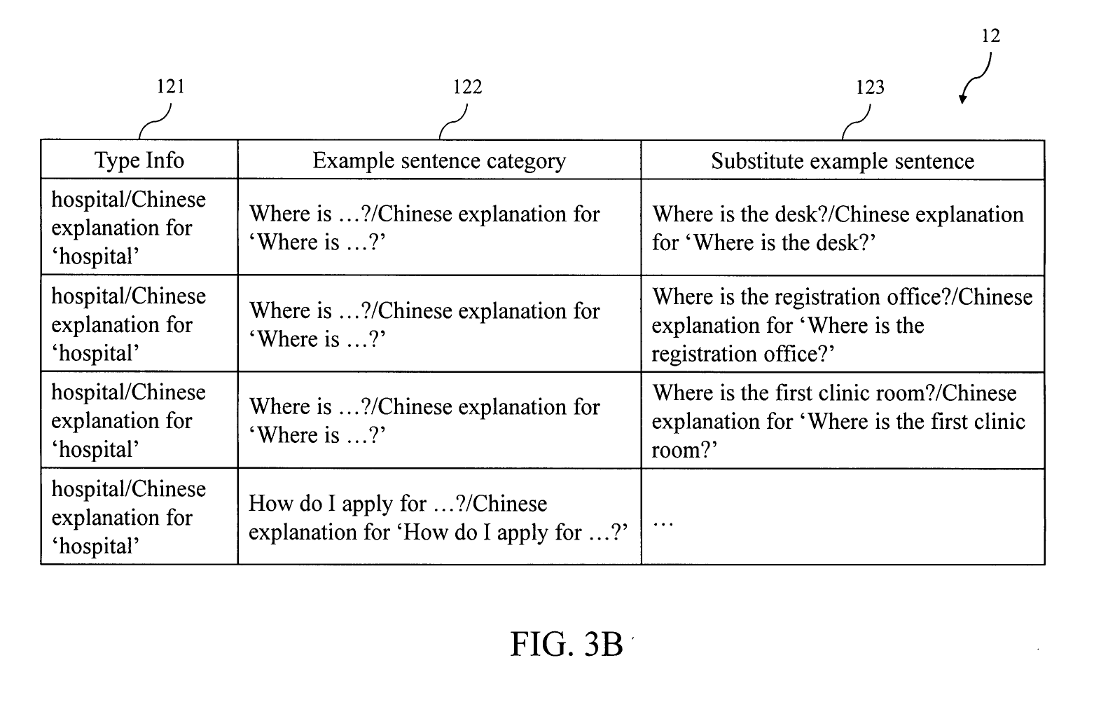

FIG. 3A is a schematic view of the geographical information database according to the invention. FIG. 3B is a schematic view of the example sentence database according to the invention.

First, the method pre-establishes a geographical information database 11 that stores name information 111, type information 112, coordinate information 113, and display information 114 (step 110). The contents are as shown in FIG. 3A and are not further described here.

Secondly, the method pre-establishes an example sentence database 12 that stores type information 121, at least one example sentence category 122, and at least one substitute example sentence 123 (step 120). The contents are as shown in FIG. 3B and are not further described here.

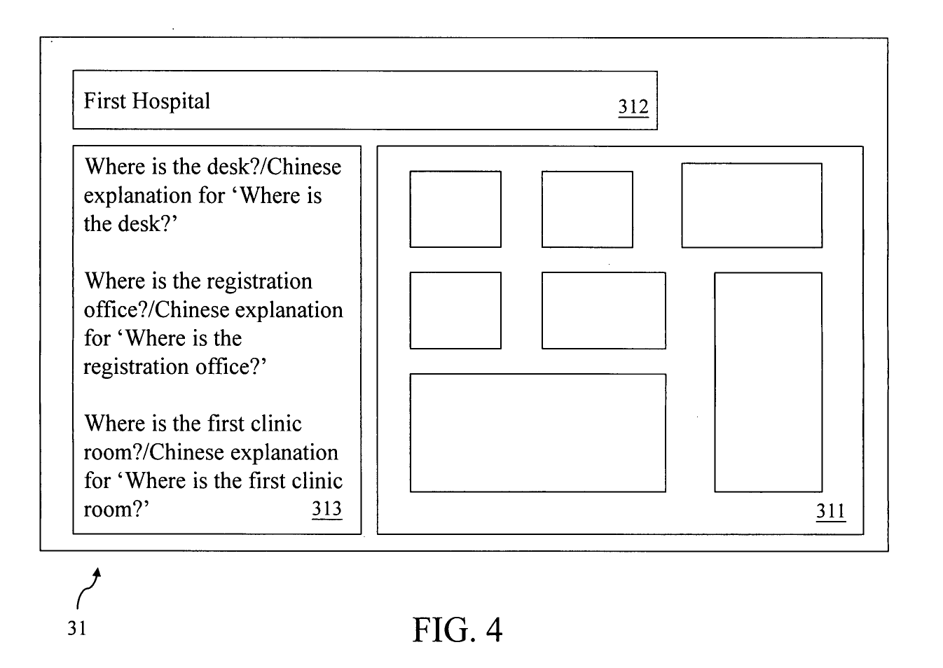

Please refer to FIG. 4, which is a schematic view of the user interface and display results according to the invention.

As shown in the drawing, the user interface 31 shown by the interface display module 13 contains an electronic map 311, an input area 312, and a display area 313 (step 130). The electronic map shown by the user interface can be pre-installed in the disclosed example sentence search and display system, or imported from some other place. The establishment of the electronic map is described before and not repeated here. The user interface 31 is referred to in FIG. 4.

In a first embodiment, suppose the search information entered by the user in the input area 312 of the user interface 31 is ‘First Hospital’. (In this case, the search information is the name information, and the first language of the user is ‘English’ and the second language is ‘Chinese’.) The receiving module 14 receives the search information ‘First Hospital’ from the input area 312 of the user interface 31 (step 140).

Afterwards, the search module 16 uses the search information ‘First Hospital’ to find the corresponding type information 112 “hospital/Chinese explanation for ‘hospital’”, and the display information 114 “The First Hospital is the largest hospital . . . /Chinese explanation for ‘The First Hospital is the largest hospital . . . ’” and the display icon “First Hospital/Chinese explanation for ‘First Hospital’” from the geographical information database 11, as shown in FIG. 3A (step 150).

The type information 121 “hospital/Chinese explanation for ‘hospital’” is then used to find the corresponding example sentence categories 122 from the example sentence database 12 (FIG. 3B) as “Where is . . . ?/Chinese explanation for ‘Where is . . . ?’” and “How do I apply for . . . ?/Chinese explanation for ‘How do I apply for . . . ?’” (step 170).

Afterwards, the display module 17 shows in the display area 313 of the user interface 31 the example sentence categories 122 “Where is . . . ?/Chinese explanation for ‘Where is . . . ?’” and “How do I apply for . . . ?/Chinese explanation for ‘How do I apply for . . . ?’” found by the search module 16 (step 180). The first language explanation and the second language translated explanation of each of the example sentence categories 122 are simultaneously shown.

Suppose the user further uses the category selection module 15 to select the example sentence category 122 “Where is . . . ?/Chinese explanation for ‘Where is . . . ?’” in the display area 313 of the user interface 31 (step 190) for further searches. The search module 16 uses the example sentence category 122 “Where is . . . ?/Chinese explanation for ‘Where is . . . ?’” to find corresponding substitute example sentences 123 from the example sentence database 12 as “Where is the desk?/Chinese explanation for ‘Where is the desk?’”, “Where is the registration office?/Chinese explanation for ‘Where is the registration office?’”, and “Where is the first clinic room?/Chinese explanation for ‘Where is the first clinic room?’” (step 200).

The display module shows in the display area 313 of the user interface the substitute example sentences 123 found by the search module 16, which are “Where is . . . ?/Chinese explanation for ‘Where is . . . ?’” to find corresponding substitute example sentences 123 from the example sentence database 12 as “Where is the desk?/Chinese explanation for ‘Where is the desk?’”, “Where is the registration office?/Chinese explanation for ‘Where is the registration office?’”, and “Where is the first clinic room?/Chinese explanation for ‘Where is the first clinic room?’” respectively (step 210). The first language explanation and the second language translated explanation of each of the substitute example sentences 123 are simultaneously shown, as illustrated in FIG. 4.

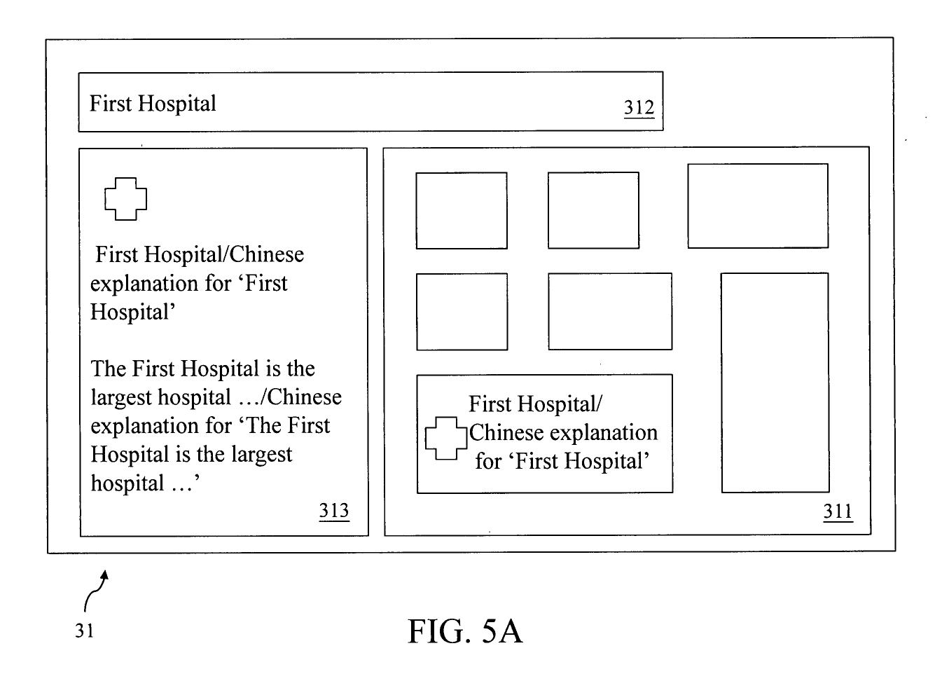

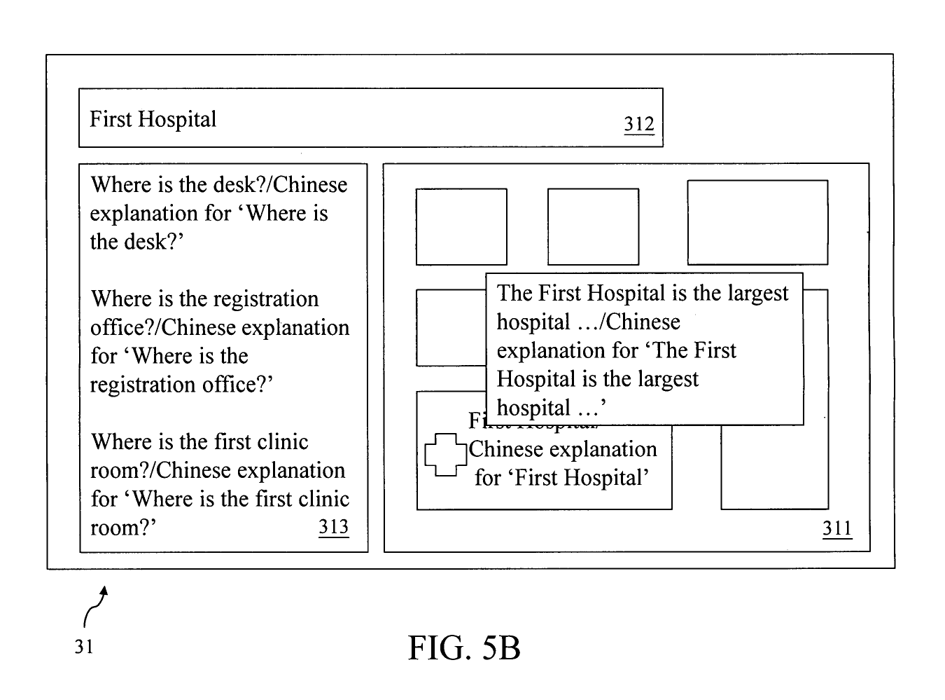

Please refer to FIG. 5A, which is a schematic view of the user interface and the display result according to the invention.

In a second embodiment, suppose the search information entered by the user in the input area 312 of the user interface 31 is ‘First Hospital’. (In this case, the search information is the name information.) The receiving module 14 receives the search information ‘First Hospital’ from the input area 312 of the user interface 31 (step 140).

The search module 16 finds from the geographical information database 11 (FIG. 3A) the corresponding type information 112 “hospital/Chinese explanation for ‘hospital’”, the display information 114 “The First Hospital is the largest hospital . . . /Chinese explanation for ‘The First Hospital is the largest hospital . . . ’” and the display icon “First Hospital/Chinese explanation for ‘First Hospital’” and the name information 111 “First Hospital/Chinese explanation for ‘First Hospital’” (step 150).

In this case, the display module 17 shows in the display area 313 of the user interface 31 the display information 114 “The First Hospital is the largest hospital . . . /Chinese explanation for ‘The First Hospital is the largest hospital . . . ’” and the name information 111 “First Hospital/Chinese explanation for ‘First Hospital’” found by the search module 16 (step 160). That is, the first language explanation and the second language translated explanation of each of the display information 114 and the name information 111 are displayed.

The user can select the display information 114 “The First Hospital is the largest hospital . . . /Chinese explanation for ‘The First Hospital is the largest hospital . . . ’” or the name information 111 “First Hospital/Chinese explanation for ‘First Hospital’” in the display area 313 of the user interface 31. Now suppose the user clicks the name information 111 “First Hospital/Chinese explanation for ‘First Hospital’” in the display area 313 of the user interface 31.

Afterwards, the search module 16 uses the selected name information 111 “First Hospital/Chinese explanation for ‘First Hospital’” to find the corresponding coordinate information 113 “121° 48′ 38″ E and 31° 25′ 17″ N/Chinese explanation for ‘121° 48″ 38″ E and 31° 25′ 17″ N’”. It further uses type information 121 “hospital/Chinese explanation for ‘hospital’” of the selected name information 111 “First Hospital/Chinese explanation for ‘First Hospital’” to find from the example sentence database 12 (FIG. 3B) at least one example sentence category 122 “Where is . . . ?/Chinese explanation for ‘Where is . . . ?’” and “How do I apply for . . . ?/Chinese explanation for ‘How do I apply for . . . ?’” (step 170).

Afterwards, the display module 17 shows in the display area 313 of the user interface 31 the example sentence categories 122 “Where is . . . ?/Chinese explanation for ‘Where is . . . ?’” and “How do I apply for . . . ?/Chinese explanation for ‘How do I apply for . . . ?’” found by the search module 16 (step 180).

The display module 17 shows the name information 111 “First Hospital/Chinese explanation for ‘First Hospital’” and the display information 114 “The First Hospital is the largest hospital . . . /Chinese explanation for ‘The First Hospital is the largest hospital . . . ’” at the place with the coordinate information 113 “121° 48′ 38″ E and 31° 25′ 17″ N/Chinese explanation for ‘121° 48′ 38″ E and 31° 25′ 17″ N’” in the electronic map 311 (step 160). The first language explanation and the second language translated explanation of each of the name information 111 and the display information 114 are simultaneously displayed.

Moreover, suppose the user uses the category selection module 15 to select the example sentence category 122 “Where is . . . ?/Chinese explanation for ‘Where is . . . ?’” in the display area 313 of the user interface 31 (step 190) for further searches.

Please refer to FIG. 5B, which is a schematic view of the user interface and search result according to the invention.

After the category selection module 15 is used to select the example sentence category 122 “Where is . . . ?/Chinese explanation for ‘Where is . . . ?’”, the search module 16 uses the example sentence category 122 “Where is . . . ?/Chinese explanation for ‘Where is . . . ?’” to find the corresponding substitute example sentences 123 from the example sentence database 12 (FIG. 3B) as respectively “Where is the desk?/Chinese explanation for ‘Where is the desk?’”, “Where is the registration office?/Chinese explanation for ‘Where is the registration office?’”, and “Where is the first clinic room?/Chinese explanation for ‘Where is the first clinic room?’” (step 200).

Afterwards, the display module 17 displays in the display area 313 of the user interface the substitute example sentences 123 found by the search module as “Where is the desk?/Chinese explanation for ‘Where is the desk?’”, “Where is the registration office?/Chinese explanation for ‘Where is the registration office?’”, and “Where is the first clinic room?/Chinese explanation for ‘Where is the first clinic room?’” (step 210). Thus, the first language explanation and the second language translated explanation of each of the substitute example sentences 123 are simultaneously displayed, as illustrated in FIG. 5B.

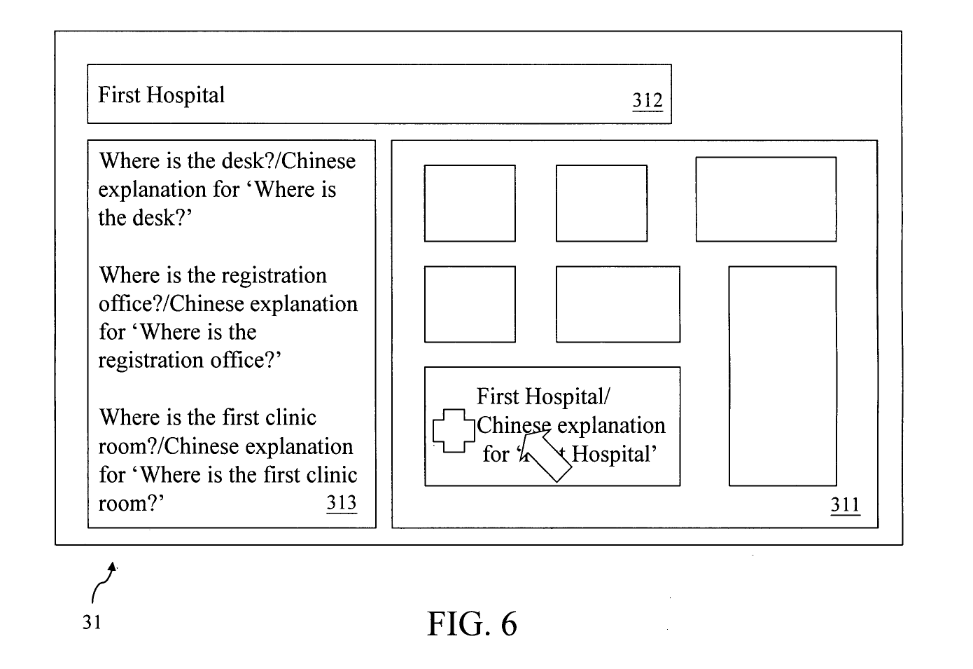

Please refer to FIG. 6, which is a schematic view of the user interface and search result according to the invention.

In a third embodiment, suppose the user click in the electronic map 311 of the user interface 31 to select the search information as ‘121° 29′43″ E and 31° 14′30″ N’. The receiving module 14 then receives the search information ‘121° 29′43″ E and 31° 14′30″ N’ from the electronic map 311 of the user interface 31 (step 140).

Afterwards, the search module 16 uses the search information ‘121° 29′43″ E and 31° 14′30″ N’ to find the corresponding type information 112 “hospital/Chinese explanation for ‘hospital’” from the geographical information database 11, as shown in FIG. 3A (step 150).

The type information 121 “hospital/Chinese explanation for ‘hospital’” is then used to find from the example sentence database 12 (FIG. 3B) the corresponding example sentence categories 122 as “Where is . . . ?/Chinese explanation for ‘Where is . . . ?’” and “How do I apply for . . . ?/Chinese explanation for ‘How do I apply for . . . ?’” (step 170).

Afterwards, the display module 17 displays in the display area 313 of the user interface 31 the example sentence categories 122 as “Where is . . . ?/Chinese explanation for ‘Where is . . . ?’” and “How do I apply for . . . ?/Chinese explanation for ‘How do I apply for . . . ?’” found by the search module 16 (step 180). The first language explanation and the second language translated explanation of each of the example sentence categories 122 are simultaneously shown.

Moreover, suppose the user uses the category selection module 15 to select the example sentence category 122 “Where is . . . ?/Chinese explanation for ‘Where is . . . ?’” in the display area 313 of the user interface 31 for further searches (step 190).

After the category selection module 15 is used to select the example sentence category 122 “Where is . . . ?/Chinese explanation for ‘Where is . . . ?’”, the search module 16 finds from the example sentence database 12 the corresponding substitute example sentences 123 as respectively “Where is the desk?/Chinese explanation for ‘Where is the desk?’”, “Where is the registration office?/Chinese explanation for ‘Where is the registration office?’”, and “Where is the first clinic room?/Chinese explanation for ‘Where is the first clinic room?’” (step 200).

Afterwards, the display module 17 displays in the display area 313 of the user interface the substitute example sentences 123 found by the search module 16 as “Where is the desk?/Chinese explanation for ‘Where is the desk?’”, “Where is the registration office?/Chinese explanation for ‘Where is the registration office?’”, and “Where is the first clinic room?/Chinese explanation for ‘Where is the first clinic room?’” (step 210). The first language explanation and the second language translated explanation of each of the substitute example sentences 123 are simultaneously shown, as illustrated in FIG. 6.

In the above-mentioned steps of displaying in the electronic map 311, the method can further adjust the size of the electronic map via a scale adjusting module 18 (step 220) so that the scale factor reaches a predetermined value. The name information 111 or the display information 114 is then shown at the place with the obtained coordinate information in the electronic map (step 230). That is, the display module 17 can show the name information 111 or the display information 114 at the place with the obtained coordinate information in the electronic map 311.

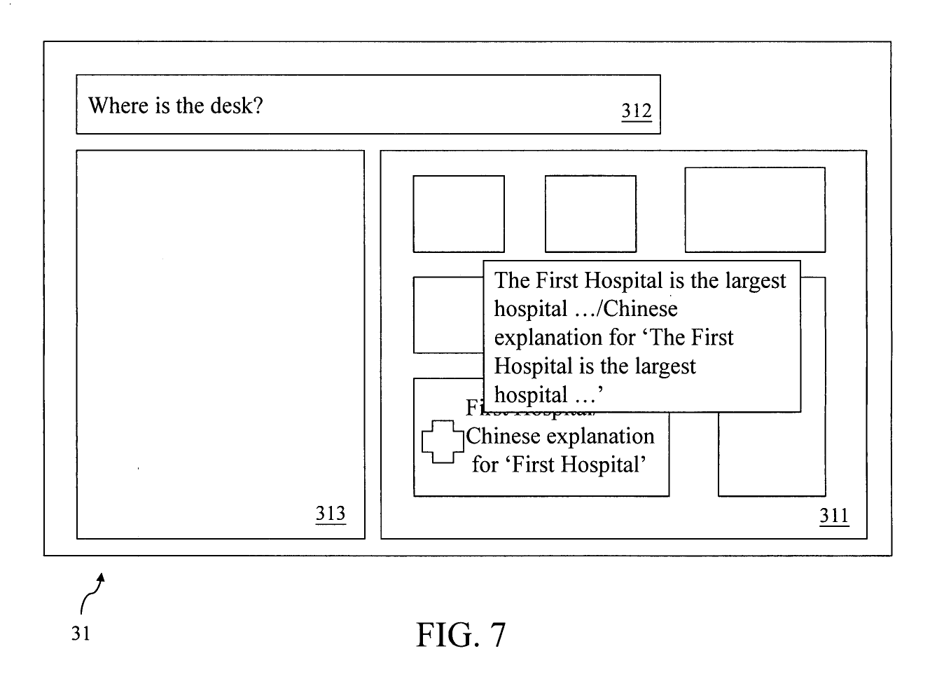

Please refer to FIG. 7, which is a schematic view of the user interface and inverse search result according to the invention.

In addition to using the search information to find substitute example sentences, the user can also enter example sentence information in the input area 312 of the user interface 31. Suppose the user enters the example sentence information ‘Where is the desk?’ in the input area 312 of the user interface 31. The receiving module 14 receives the example sentence information ‘Where is the desk?’ from the input area 312 of the user interface 31 (step 240).

After receiving module 14 receives the example sentence information ‘Where is the desk?’, the search module 16 compares the example sentence information ‘Where is the desk?’ with at least one substitute example sentence 123 stored in the example sentence database 12 (see FIG. 3B). In this embodiment, the example sentence database 12 stores the substitute example sentence 123 “Where is the desk?/Chinese explanation for ‘Where is the desk?’”.

Therefore, the search module 16 finds that the search information ‘Where is the desk?’ matches with the substitute example sentence 123 “Where is the desk?/Chinese explanation for ‘Where is the desk?’” in the example sentence database 12. Moreover, the search module 16 finds the type information 121 corresponding to the substitute example sentence 123 “Where is the desk?/Chinese explanation for ‘Where is the desk?’” as “hospital/Chinese explanation for ‘hospital’” (step 250).

The search module 16 then uses the type information 112 “hospital/Chinese explanation for ‘hospital’” to find in the geographical information database 11 (see FIG. 3A) the corresponding name information 111 “First Hospital/Chinese explanation for ‘First Hospital’”, the coordinate information “121° 48′ 38″ E and 31° 25′ 17″ N/Chinese explanation for ‘121° 48′ 38″ E and 31° 25′ 17″ N’”, and the display information 114 “The First Hospital is the largest hospital . . . /Chinese explanation for ‘The First Hospital is the largest hospital . . . ’” and the display icon “First Hospital/Chinese explanation for ‘First Hospital’”, as shown in FIG. 3A (step 260).

Afterwards, the display module 17 displays the name information 111 “First Hospital/Chinese explanation for ‘First Hospital’” or the display information 114 “The First Hospital is the largest hospital . . . /Chinese explanation for ‘The First Hospital is the largest hospital . . . ”’ and the display icon “First Hospital/Chinese explanation for ‘First Hospital’” in the display area 313 of the user interface 31 (step 270). The display result is shown in FIG. 7.

The user uses the selection module 19 to select in the display area 313 of the user interface 31 one of the name information 111 “First Hospital/Chinese explanation for ‘First Hospital’” or the display information 114 “The First Hospital is the largest hospital . . . /Chinese explanation for ‘The First Hospital is the largest hospital . . . ’” and the display icon “First Hospital/Chinese explanation for ‘First Hospital’” (step 280).

Afterwards, the display module 17 shows at the place in the electronic map 311 with the coordinate information 113 “121° 48′ 38″ E and 31° 25′ 17″ N/Chinese explanation for ‘121° 48′ 38″ E and 31° 25′ 17″ N’” that corresponds to the selected name information 111 “First Hospital/Chinese explanation for ‘First Hospital’” or the display information 114 “The First Hospital is the largest hospital . . . /Chinese explanation for ‘The First Hospital is the largest hospital . . . ’” and the display icon “First Hospital/Chinese explanation for ‘First Hospital’” the selected name information 111 “First Hospital/Chinese explanation for ‘First Hospital’” or the display information 114 “The First Hospital is the largest hospital . . . /Chinese explanation for ‘The First Hospital is the largest hospital . . . ’” and the display icon “First Hospital/Chinese explanation for ‘First Hospital’” (step 290). The display result is shown in FIG. 7.

Before the display module 17 shows the selected name information 111 “First Hospital/Chinese explanation for ‘First Hospital’” or the display information 114 “The First Hospital is the largest hospital . . . /Chinese explanation for ‘The First Hospital is the largest hospital . . . ’” and the display icon “First Hospital/Chinese explanation for ‘First Hospital’”, the scale adjusting module 18 first adjusts the size of the electronic map 311 in the user interface 31 (step 220) so that the scale factor reaches a default value. The name information 111 “First Hospital/Chinese explanation for ‘First Hospital’” or the display information 114 “The First Hospital is the largest hospital . . . /Chinese explanation for ‘The First Hospital is the largest hospital . . . ’” and the display icon “First Hospital/Chinese explanation for ‘First Hospital’” are then displayed in the electronic map 311 in the user interface 31 (step 230).

In summary, the invention differs from the prior art in that the invention shows the input area, the display area, and the electronic map in the user interface, and receives search information from there. The search information can be the name information, the type information, or the coordinate information. The corresponding type information and display information are found from the geographical information database according to the search information. At least one corresponding example sentence category is obtained from the example sentence database according to the type information. After the user selects one example sentence category, at least one substitute example sentence is correspondingly obtained from the example sentence database. The at least one substitute example sentence is then shown in the display area of the user interface. Moreover, the name information or the display information can be shown in the electronic map.

The disclosed technique can avoid fixed conversation example sentences as in the prior art. It solves the problem that conversation example sentences cannot match the current geographical information of the user. The invention thus achieves the goal of providing example sentences compliant with geographical information.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A search and display system that provides example sentences compliant with geographical information, comprising:
a geographical information database storing name information, type information, coordinate information, and display information, each of which is stored in a first language explanation and a second language translated explanation;
an example sentence database storing the type information, at least one example sentence category, and at least one substitute example sentence, each of which is stored in a first language explanation and a second language translated explanation;
an interface display module for displaying a user interface that contains an electronic map, an input area, and a display area;
a receiving module for receiving search information from the input area, the display area, or the electronic map, with the search information being one of the name information, the type information, and the coordinate information;
a category selection module for selecting one of the example sentence categories;
a search module for finding from the geographical information database the type information and the display information corresponding to the search information and finding from the example sentence database at least one example sentence category corresponding to the type information or finding from the example sentence database at least one substitute example sentence corresponding to the selected example sentence category; and
a display module for displaying the name information, the display information, the at least one example sentence category or the at least one substitute example sentence in the display area, or displaying the name information or the display information in the electronic map.

2. The search and display system that provides example sentences compliant with geographical information according to claim 1 further comprising a scale adjusting module for adjusting the size of the electronic map according to a scale factor and displaying the display information in the electronic map via the display module when the scale factor reaches a predetermined value.

3. The search and display system that provides example sentences compliant with geographical information according to claim 1, wherein the receiving module further receives example sentence information from the input area, the search module compares the example sentence information with the at least one substitute example sentence in order to find out the corresponding type information from the example sentence database, the type information is used to find the corresponding name information, coordinate information and display information in the geographical information database, the display module displays the name information or the display information in the display area, and, when the selection module selects the name information or display information, the display module displays the selected name information or display information at the place with the coordinate information in the electronic map.

4. The search and display system that provides example sentences compliant with geographical information according to claim 1, wherein the electronic map is pre-installed in the system or imported into the system, and consists of an information layer, a coordinate layer, and a map layer.

5. A search and display method that provides example sentences compliant with geographical information, comprising the steps of:
pre-establishing a geographical information database containing name information, type information, coordinate information, and display information, each of which is stored in a first language explanation and a second language translation explanation;
pre-establishing an example sentence database storing the type information, at least one example sentence category, and at least one substitute example sentence, each of which is stored in a first language explanation and a second language translated explanation;
displaying a user interface containing an electronic map, an input area, and a display area;
receiving search information from the input area, the display area, or the electronic map, with the search information being one of the name information, the type information and the coordinate information;
finding in the geographical information database the type information and the display information corresponding to the search information;
displaying the display information in the display area or the electronic map;
finding in the example sentence database at least one example sentence category corresponding to the type information;
displaying at least one example sentence category in the display area;
selecting one of the example sentence categories;
finding in the example sentence database the at least one substitute example sentence according to the example sentence category; and
displaying at least one substitute example sentence in the display area.

6. The search and display method that provides example sentences compliant with geographical information according to claim 5 further comprising the step of adjusting the size of the electronic map according to a scale factor and the step of displaying the display information in the display area or in the electronic map is performed when the scale factor reaches a predetermined value.

7. The search and display method that provides example sentences compliant with geographical information according to claim 5 further comprising the steps of:
receiving example sentence information from the input area;
comparing the example sentence information with the at lease one substitute example sentence in order to find the corresponding type information in the example sentence database;
finding the name information, the coordinate information, and the display information in the geographical information database according to the type information;
displaying the name information or the display information in the display area;
selecting one of the name information and the display information; and
displaying the selected name information or display information at a place with the coordinate information in the electronic map.

8. The search and display method that provides example sentences compliant with geographical information according to claim 5, wherein the electronic map is pre-installed in the system or imported into the system, and consists of an information layer, a coordinate layer, and a map layer.
